(19) United States
(12) Patent Application Publication
(10) Pub. No.: US 2026/0142296 A1
(43) Pub. Date: May 21, 2026

(54) EDGE GUARDS FOR SOLID STATE BATTERIES

(71) Applicant: Ford Global Technologies, LLC, Dearborn, MI (US)

(72) Inventors: Jiyun Park, Troy, MI (US); Soo Yeon Lim, Canton, MI (US); Claudia Jazowski, Ferndale, MI (US); Gang Guo, Saline, MI (US)

(21) Appl. No.: 18/954,668

(22) Filed: Nov. 21, 2024

(51) Int. Cl. H01M 50/244; H01M 50/227; H01M 50/238; H01M 50/249

(52) U.S. Cl. CPC H01M 50/244; H01M 50/227; H01M 50/238; H01M 50/249

(57) ABSTRACT

A battery fabrication system and method include stacking a plurality of unit battery cells, which each have an electrolyte, to provide a cell stack having a plurality of edges, installing at least one edge guard to cover at least one edge of the plurality of edges, and enclosing the cell stack and the edge guard within a pouch. The pouch is then shrunk around the cell stack and the edge guard.

### TECHNICAL FIELD

This disclosure relates generally to a battery edge guard system, and associated method of assembly, for solid-state batteries used in electrified vehicles.

### BACKGROUND

Electrified vehicles differ from conventional motor vehicles because electrified vehicles include a drivetrain having one or more electric machines. A battery pack can power the electric machines. The battery pack can include arrays of solid-state battery cells.

### SUMMARY

In some aspects, the techniques described herein relate to a battery fabrication method, including: stacking a plurality of unit battery cells, with each unit battery cell including an electrolyte, to provide a cell stack having a plurality of edges; installing at least one edge guard to cover at least one edge of the plurality of edges; enclosing the cell stack and the at least one edge guard within a pouch; and shrinking the pouch around the cell stack and the at least one edge guard.

In a further non-limiting embodiment of any method, the electrolyte comprises a solid electrolyte, and wherein each unit battery cell comprises an anode, a solid electrolyte, and a cathode.

In a further non-limiting embodiment of any method, shrinking the pouch includes degassing the pouch with a vacuum pump.

In a further non-limiting embodiment of any method, the method includes forming the at least one edge guard from a rigid material.

In a further non-limiting embodiment of any method, both the pouch and the cell stack are flexible prior to shrinking.

In a further non-limiting embodiment of any method, the plurality of edges comprise a first side edge, a second side edge, a third side edge extending between the first side edge and the second side edge, and a fourth side edge that is opposite of the third side edge and extends between the first side edge and the second side edge, and the method includes covering the first side edge and at least portions of the third side edge and the fourth side edge with the at least one edge guard.

In a further non-limiting embodiment of any method, the at least one edge guard comprises at least a first edge guard and a second edge guard, and the method includes: covering the first side edge and at least portions of the third side edge and the fourth side edge with the first edge guard; and covering the second side edge and at least portions of the third side edge and the fourth side edge with the second edge guard.

In a further non-limiting embodiment of any method, the plurality of edges further comprises an upper edge and a lower edge opposite the upper edge, the upper edge and the lower edge extending around a periphery of the cell stack, and the method includes covering at least one of the upper edge and the lower edge with a respective upper lip or lower lip extending outwardly of the at least one edge guard.

In a further non-limiting embodiment of any method, the method includes covering the upper edge with the upper lip and covering the lower edge with the lower lip.

In a further non-limiting embodiment of any method, the at least one edge guard comprises at least a first edge guard and a second edge guard, and the method includes: using the first edge guard to cover the first side edge, at least portions of the third side edge and the fourth side edge, and at least one of the upper edge and the lower edge with a respective upper lip or lower lip extending outwardly of the first edge guard; and using the second edge guard to cover the second side edge, at least portions of the third side edge and the fourth side edge, and at least one of the upper edge and the lower edge with a respective upper lip or lower lip extending outwardly of the second edge guard.

In some aspects, the techniques described herein relate to a battery fabrication system, including: a plurality of unit battery cells each having an electrolyte, the plurality of battery cells being stacked on top of each other to provide a cell stack having a plurality of edges; at least one edge guard covering at least one edge of the plurality of edges; a pouch that encloses the cell stack and the at least one edge guard; and a degassing system that shrinks the pouch around the cell stack and the at least one edge guard.

In a further non-limiting embodiment of any system, the electrolyte comprises a solid electrolyte, and wherein each unit battery cell comprises an anode, a solid electrolyte, and a cathode.

In a further non-limiting embodiment of any system, the degassing system includes a vacuum pump.

In a further non-limiting embodiment of any system, the at least one edge guard is formed from a rigid material.

In a further non-limiting embodiment of any system, both the pouch and the cell stack are flexible prior to shrinking.

In a further non-limiting embodiment of any system, the plurality of edges comprise a first side edge, a second side edge, a third side edge extending between the first side edge and the second side edge, and a fourth side edge that is opposite of the third side edge and extends between the first side edge and the second side edge, and wherein the at least one edge guard covers the first side edge and at least portions of the third side edge and the fourth side edge.

In a further non-limiting embodiment of any system, the at least one edge guard comprises at least a first edge guard and a second edge guard, and wherein: the first edge guard covers the first side edge and at least portions of the third side edge and the fourth side edge; and the second edge guard covers the second side edge and at least portions of the third side edge and the fourth side edge.

In a further non-limiting embodiment of any system, the plurality of edges further comprises an upper edge and a lower edge opposite the upper edge, the upper edge and the lower edge extending around a periphery of the cell stack; and wherein the at least one edge guard covers at least one of the upper edge and the lower edge with a respective upper lip or lower lip extending outwardly of the at least one edge guard.

In a further non-limiting embodiment of any system, the upper edge is covered with the upper lip and the lower edge is covered with the lower lip.

In a further non-limiting embodiment of any system, the at least one edge guard comprises at least a first edge guard and a second edge guard, and wherein: the first edge guard covers the first side edge, at least portions of the third side edge and the fourth side edge, and at least one of the upper edge and the lower edge with a respective upper lip or lower lip extending outwardly of the first edge guard; and the second edge guard covers the second side edge, at least portions of the third side edge and the fourth side edge, and at least one of the upper edge and the lower edge with a respective upper lip or lower lip extending outwardly of the second edge guard.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates a perspective view of the traction battery pack from the electrified vehicle of FIG. 1.

FIG. 3 illustrates a perspective sketch of the stack of SSB cells from the traction battery pack of FIG. 2.

FIG. 4 illustrates a perspective sketch of the stack of SSB cells from FIG. 3 with one example of an edge guard.

FIG. 5 illustrates a perspective sketch of the stack of SSB cells from FIG. 3 with another example of an edge guard.

FIG. 6 illustrates a perspective sketch of the stack of SSB cells from FIG. 3 with another example of an edge guard.

### DETAILED DESCRIPTION

This disclosure details a battery edge guard system for solid-state batteries used in electrified vehicles. This disclosure also details an associated method of assembly for the solid-state batteries and edge guard system.

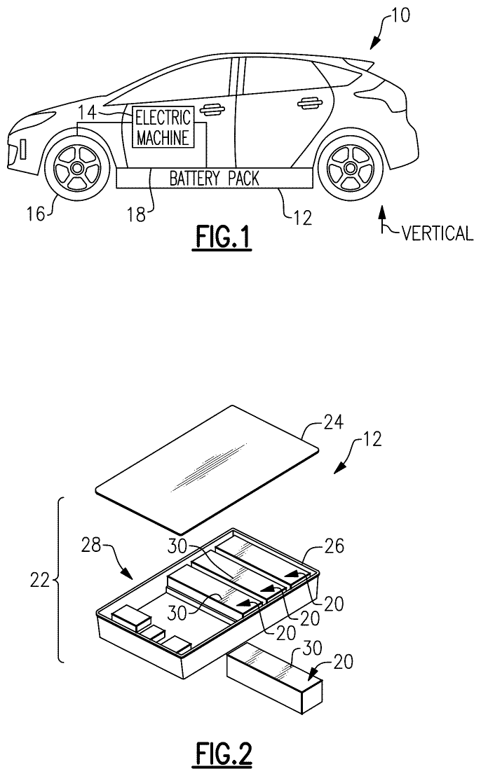

With reference to FIG. 1, an electrified vehicle 10 includes a battery pack 12, an electric machine 14, and wheels 16. The battery pack 12 powers an electric machine 14, which can convert electrical power to mechanical power to drive the wheels 16. The battery pack 12 can be a relatively high-voltage battery.

The battery pack 12 is, in the exemplary embodiment, secured to an underbody 18 of the electrified vehicle 10. The battery pack 12 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference now to FIG. 2, the battery pack 12 includes a plurality of battery arrays 20 held within an enclosure assembly 22. In the exemplary embodiment, the enclosure assembly 22 includes an enclosure cover 24 and an enclosure tray 26. The enclosure cover 24 is secured to the enclosure tray 26 to provide an interior area 28 that houses the plurality of battery arrays 20.

The battery arrays 20 each include a group of battery cells 30 stacked side-by side relative to each other. These groups of battery cells 30 supply electrical power to various components of the electrified vehicle 10. In implementations, the battery cells 30 are solid-state battery (SSB) cells, which include electrodes and a solid electrolyte, instead of the liquid or polymer gel electrolytes found in lithium-ion or lithium polymer batteries.

The groups of battery cells 30 are arranged side-by-side to provide the battery arrays 20. Although a specific number of cells 30 and arrays 20 are illustrated in FIG. 2, the battery pack 12 could include any number of arrays 20 having any number of cells 30. In other words, this disclosure is not limited to the specific configuration of cells 30 and arrays 20 shown in FIG. 2.

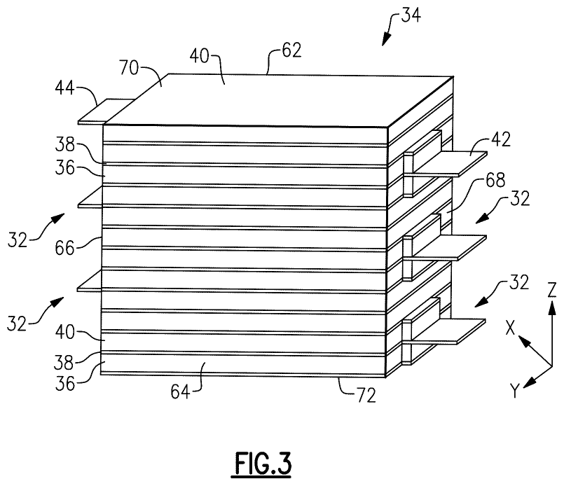

Referring to FIG. 3, a plurality of individual/unit SSB battery cells 32 are stacked on top of one another in a z-direction to form a group stack 34. Each unit SSB cell 32 includes an anode 36, a solid electrolyte 38, and a cathode 40. On the individual SSB cell level, the anode 36, solid electrolyte 38, and cathode 40 are stacked on one another in the z-direction with the solid electrolyte being sandwiched between the anode 36 and the cathode 40.

In implementations, the SSB cell 32 further includes an anode current collector 42 and a cathode current collector 44. In implementations, the anode current collector 42 is arranged on the surface of anode 36 opposite from the surface of the anode facing solid electrolyte 38. Likewise, cathode current collector 44 is arranged on the surface of cathode 40 opposite from the surface of the cathode facing solid electrolyte 38.

In implementations, a portion of the anode current collector 42 in the form of a tab extends out from a body of the SSB cell 32. Likewise, a portion of cathode current collector 44 in the form of a tab extends out from a body of the SSB cell 32. In this example, the anode current collector tab and the cathode collector tab extend out from a body of the SSB cell 32 past edges of the group stack 34. The tabs are accessible to be respectively connected to the tabs of the current collectors of other SSB cells 32 in group stack 34 for SSB cells 32 to be connected in series or in parallel with one another. It should be understood that this is just one example of SSB cells 32 in a group stack 34, and that other cell 32 and stack 34 configurations could be used.

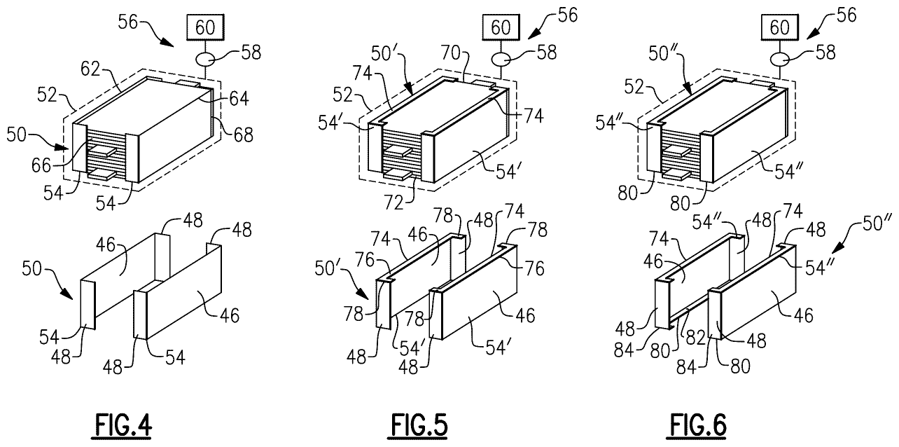

FIG. 4 shows an example of a battery edge guard system 50 that is used to protect the SSB cells 32 during pack formation. During pack formation, the SSB cells 32 are enclosed within a pouch 52, and a subsequent degassing process takes place that causes the pouch 52 to shrink around the stack 34. In implementations, this vacuum process could be after formation, or possibly just during packing in case formation is not required for certain types of SSBs. During this process, the SSB cells 32 may face unique challenges due to their solid material composition. For example, during the degassing process, the flexible pouch 52 around the cell stack 34 undergoes an abrupt volume reduction, which may cause adverse structural contact, particularly around edges of the stack 34.

The subject disclosure provides the battery edge guard system 50 to protect the edges during the degassing process. These edge guards may be provided in different shaped designs and configurations to protect cell edges from any issues caused by irregular pouch shrinkage, ensuring the integrity and performance of SSB electrodes during manufacturing. FIGS. 4-6 show different examples of edge guard configurations.

Referring to FIG. 4, the battery edge guard system 50 includes a plurality of individual SSB battery cells 32 each having an electrolyte portion 38, and the cells 32 are stacked on top of each other to provide the cell stack 34, which has a plurality of edges. In implementations, the electrolyte portions 38 comprise solid electrolytes. In implementations, at least one edge guard 54 covers at least one edge of the plurality of edges. The pouch 52 encloses the cell stack 34 and the edge guard 34, and a degassing system 56 shrinks the pouch 52 around the cell stack 34 and the edge guard 54.

In implementations, the edge guard 54 is formed from a rigid material. In implementations, the edge guards are also electronically insulating, resistant to the battery's operating temperature, chemically stable, and have a low density to ensure the edge guards do not interfere with battery performance or affect energy density.

In one example, the edge guard 54 may be a thin component, e.g., approximately 1 mm, to provide sufficient protection for the edges. In implementations, possible candidate materials include: Polyimide; Polyetheretherketone; or Polyetherimide. Polyimide has a temperature resistance of up to 300° C., has a dielectric constant of 3.4, and has a density (g/cm³) of 1.42. Polyetheretherketone has a temperature resistance of up to 250° C., has a dielectric constant of 3.2, and has a density (g/cm³) of 1.3. Polyetherimide has a temperature resistance of up to 200° C., has a dielectric constant of 3.15, and has a density (g/cm³) of 1.27. It should be understood that these are merely examples of suitable materials, and that other suitable materials may also be used.

In implementations, the degassing system 56 includes a vacuum pump 58 and a controller 60 that controls the pump 58. During manufacturing, the stack 34 is placed inside the pouch 52 and the pouch 52 is degassed with the vacuum pump 58. This causes the pouch 52 to shrink around the stack 34.

In implementations, the pouch 52 may be made from a thin sheet of polymer and metal. In one example, the thin sheet may be approximately four mm thick.

In implementations, as both the pouch 52 and the cell stack 34 are flexible prior to shrinking, during the vacuum sealing process the vacuum causes the pouch 52 to squeeze around the edges which may result in an adverse effect to the edges. For example, the sudden volume reduction inside the pouch 52 may lead to irregular wrinkles, which can cause issues in the edge region of the cell stack and adversely affect cell performance.

As shown in FIG. 3, the plurality of edges comprise a first side edge 62, a second side edge 64, a third side edge 66 extending between the first side edge 62 and the second side edge 64, and a fourth side edge 68 that is opposite of the third side edge 66 and extends between the first side edge 62 and the second side edge 64. In implementations, one edge guard 54 covers the first side edge 62 and at least portions of the third side edge 66 and the fourth side edge 68 as shown in FIG. 4.

In one example, the edge guard 54 covers an entirety of the first side edge 62 and only small portions of the third side edge 66 and the fourth side edge 68. This leaves a center portion of the edges 66, 68 uncovered to accommodate the respective collector tabs.

In implementations, one edge guard 54 covers the first side edge 62 and portions of the third side edge 66 and the fourth side edge 68, and another edge guard 54 covers the second side edge 64 and portions of the third side edge 66 and the fourth side edge 68 (FIG. 4).

In implementations, the edge guards 54 shown in FIG. 4 comprise a U-shaped configuration. The U-shaped configuration comprises a generally flat planar panel 46 that covers an entirety of the first side 62 of the stack 34, and a pair of flat, planar side panels 48 that extend transversely to the main planar panel 46 to cover portions of the third 66 and fourth 68 side edges.

Further, as shown in FIG. 3, the plurality of edges also comprises an upper edge 70 and a lower edge 72 opposite the upper edge, the upper edge 70 and the lower edge 72 extending around a periphery of the cell stack 34.

In the example shown in FIG. 5, a battery edge guard system 50′ includes an edge guard 54′ that covers the first side edge 62 and portions of the third side edge 66 and the fourth side edge 68 as shown in FIG. 4, and also covers at least one of the upper edge 70 and the lower edge 72 with a respective upper lip or lower lip extending outwardly of the edge guard 54′. In the example shown, the edge guard 54′ includes an upper lip 74 that extends inward over a topmost surface of the stack 34 to cover a portion of the upper edge 70. In other implementations, a lower lip may extend over the bottommost surface of the stack.

In implementations, one edge guard 54′ covers the first side edge 62 and portions of the third side edge 66 and the fourth side edge 68, another edge guard 54′ covers the second side edge 64 and portions of the third side edge 66 and the fourth side edge 68, and the upper lip 74 of each edge guard 54′ covers a portion of the upper edge 70 (FIG. 5).

In implementations, the edge guards 54′ shown in FIG. 5 comprise a U-shaped configuration with an L-shaped portion covering the top edge 70. The U-shaped configuration comprises the main planar panel 46 and side panels 48 as shown in FIG. 4, with the L-shaped portion comprising the upper lip 74. In one example, the upper lip 74 includes a main flat panel portion 76 and a pair of flat extension panels 78 that extend inwardly toward each other from opposing ends of the main panel portion 76. In one example, the main panel portion 76 is elongated and narrow, with the pair of flat extension panels 78 being significantly shorter in length.

In the example shown in FIG. 6, a battery edge guard system 50″ includes an edge guard 54″ that covers the first side edge 62 and portions of the third side edge 66 and the fourth side edge 68 as shown in FIG. 4, and also covers the upper edge 70 with an upper lip 74 as shown in FIG. 5, as well as covering the lower edge 72 with a lower lip 80 extending outwardly of a bottom edge of the edge guard 54″. In the example shown, the edge guard 54″ includes the upper lip 74 that extends inward over the topmost surface of the stack 34 to cover a portion of the upper edge 70, and also includes the lower lip 80 that extends inward over the bottommost surface of the stack 34 to cover a portion of the lower edge 72.

In implementations, one edge guard 54″ covers the first side edge 62 and portions of the third side edge 66 and the fourth side edge 68, another edge guard 54″ covers the second side edge 64 and portions of the third side edge 66 and the fourth side edge 68, the upper lip 74 of each edge guard 54″ covers a portion of the upper edge 70, and the lower lip 80 of each edge guard 54″ covers a portion of the lower edge 72 (FIG. 6).

In implementations, the edge guards 54″ shown in FIG. 6 comprise a U-shaped configuration such as that shown in FIG. 4 with an additional U-shaped portion covering the top edge 70 and the bottom edge 72. The U-shaped configuration comprises the main planar panel 46 and side panels 48 as shown in FIG. 4, with the additional U-shaped portion comprising the upper lip 74 and lower lip 80. In one example, the upper lip 74 is configured as shown in FIG. 5, and the lower lip 80 includes a main flat panel portion 82 and a pair of flat extension panels 84 that extend inwardly toward each other from opposing ends of the main panel portion 82. In one example, the main panel portion 82 is elongated and narrow, with the pair of flat extension panels 84 being significantly shorter in length.

A method of assembling a battery is also disclosed. In implementations, the method includes stacking a plurality of unit battery cells each having an electrolyte portion to provide a cell stack having a plurality of edges, installing at least one edge guard to cover at least one edge of the plurality of edges; enclosing the cell stack and the at least one edge guard within a pouch; and shrinking the pouch around the cell stack and the at least one edge guard.

The method may also include any of the following steps either alone or in any combination thereof.

In implementations, the method may include wherein the electrolyte portion comprises a solid electrolyte.

In implementations, the method may include wherein shrinking the pouch includes degassing the pouch with a vacuum pump.

In implementations, the method may include forming the at least one edge guard from a rigid material.

In implementations, the method may include wherein both the pouch and the cell stack are flexible prior to shrinking.

In implementations, the method may include wherein the plurality of edges comprise a first side edge, a second side edge, a third side edge extending between the first side edge and the second side edge, and a fourth side edge that is opposite of the third side edge and extends between the first side edge and the second side edge, and the method including covering the first side edge and at least portions of the third side edge and the fourth side edge with the at least one edge guard.

In implementations, the method may include wherein the at least one edge guard comprises at least a first edge guard and a second edge guard, and the method including: covering the first side edge and at least portions of the third side edge and the fourth side edge with the first edge guard; and covering the second side edge and at least portions of the third side edge and the fourth side edge with the second edge guard.

In implementations, the method may include wherein the plurality of edges further comprises an upper edge and a lower edge opposite the upper edge, the upper edge and the lower edge extending around a periphery of the cell stack; and the method including covering at least one of the upper edge and the lower edge with a respective upper lip or lower lip extending outwardly of the at least one edge guard.

In implementations, the method may include covering the upper edge with the upper lip and covering the lower edge with the lower lip.

In implementations, the method may include wherein the at least one edge guard comprises at least a first edge guard and a second edge guard, and the method including: using the first edge guard to cover the first side edge, at least portions of the third side edge and the fourth side edge, and at least one of the upper edge and the lower edge with a respective upper lip or lower lip extending outwardly of the first edge guard; and using the second edge guard to cover the second side edge, at least portions of the third side edge and the fourth side edge, and at least one of the upper edge and the lower edge with a respective upper lip or lower lip extending outwardly of the second edge guard.

Thus, the subject disclosure provides for an edge guard arrangement that is designed to physically cover the edges of cell stacks to help withstand contact during the cell degassing process. These edge guards may protect electrode edges from any issues caused by the abrupt and irregular shrinkage of the flexible pouch. In implementations, the edge guards may be made from a thin plastic material which is electronically insulating and temperature resistant. The edge guards are mounted after stacking the electrode cell sheets and prior to degassing.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery fabrication method, comprising:
stacking a plurality of unit battery cells, with each unit battery cell including an electrolyte, to provide a cell stack having a plurality of edges;
installing at least one edge guard to cover at least one edge of the plurality of edges;
enclosing the cell stack and the at least one edge guard within a pouch; and
shrinking the pouch around the cell stack and the at least one edge guard.

2. The battery fabrication method of claim 1, wherein the electrolyte comprises a solid electrolyte, and wherein each unit battery cell comprises an anode, a solid electrolyte, and a cathode.

3. The battery fabrication method of claim 1, wherein shrinking the pouch includes degassing the pouch with a vacuum pump.

4. The battery fabrication method of claim 1, including forming the at least one edge guard from a rigid material.

5. The battery fabrication method of claim 1, wherein both the pouch and the cell stack are flexible prior to shrinking.

6. The battery fabrication method of claim 1, wherein the plurality of edges comprise a first side edge, a second side edge, a third side edge extending between the first side edge and the second side edge, and a fourth side edge that is opposite of the third side edge and extends between the first side edge and the second side edge, and including
covering the first side edge and at least portions of the third side edge and the fourth side edge with the at least one edge guard.

7. The battery fabrication method of claim 6, wherein the at least one edge guard comprises at least a first edge guard and a second edge guard, and including:
covering the first side edge and at least portions of the third side edge and the fourth side edge with the first edge guard; and
covering the second side edge and at least portions of the third side edge and the fourth side edge with the second edge guard.

8. The battery fabrication method of claim 6, wherein the plurality of edges further comprises an upper edge and a lower edge opposite the upper edge, the upper edge and the lower edge extending around a periphery of the cell stack, and including
covering at least one of the upper edge and the lower edge with a respective upper lip or lower lip extending outwardly of the at least one edge guard.

9. The battery fabrication method of claim 8, including covering the upper edge with the upper lip and covering the lower edge with the lower lip.

10. The battery fabrication method of claim 8, wherein the at least one edge guard comprises at least a first edge guard and a second edge guard, and including:
using the first edge guard to cover the first side edge, at least portions of the third side edge and the fourth side edge, and at least one of the upper edge and the lower edge with a respective upper lip or lower lip extending outwardly of the first edge guard; and
using the second edge guard to cover the second side edge, at least portions of the third side edge and the fourth side edge, and at least one of the upper edge and the lower edge with a respective upper lip or lower lip extending outwardly of the second edge guard.

11. A battery fabrication system, comprising:
a plurality of unit battery cells each having an electrolyte, the plurality of unit battery cells being stacked on top of each other to provide a cell stack having a plurality of edges;
at least one edge guard covering at least one edge of the plurality of edges;
a pouch that encloses the cell stack and the at least one edge guard; and
a degassing system that shrinks the pouch around the cell stack and the at least one edge guard.

12. The battery fabrication system of claim 11, wherein the electrolyte comprises a solid electrolyte, and wherein each unit battery cell comprises an anode, a solid electrolyte, and a cathode.

13. The battery fabrication system of claim 11, wherein the degassing system includes a vacuum pump.

14. The battery fabrication system of claim 11, wherein the at least one edge guard is formed from a rigid material.

15. The battery fabrication system of claim 11, wherein both the pouch and the cell stack are flexible prior to shrinking.

16. The battery fabrication system of claim 11, wherein the plurality of edges comprise a first side edge, a second side edge, a third side edge extending between the first side edge and the second side edge, and a fourth side edge that is opposite of the third side edge and extends between the first side edge and the second side edge, and wherein
the at least one edge guard covers the first side edge and at least portions of the third side edge and the fourth side edge.

17. The battery fabrication system of claim 16, wherein the at least one edge guard comprises at least a first edge guard and a second edge guard, and wherein:
the first edge guard covers the first side edge and at least portions of the third side edge and the fourth side edge; and
the second edge guard covers the second side edge and at least portions of the third side edge and the fourth side edge.

18. The battery fabrication system of claim 16, wherein the plurality of edges further comprises an upper edge and a lower edge opposite the upper edge, the upper edge and the lower edge extending around a periphery of the cell stack; and wherein
the at least one edge guard covers at least one of the upper edge and the lower edge with a respective upper lip or lower lip extending outwardly of the at least one edge guard.

19. The battery fabrication system of claim 18, wherein the upper edge is covered with the upper lip and the lower edge is covered with the lower lip.

20. The battery fabrication system of claim 18, wherein the at least one edge guard comprises at least a first edge guard and a second edge guard, and wherein:
the first edge guard covers the first side edge, at least portions of the third side edge and the fourth side edge, and at least one of the upper edge and the lower edge with a respective upper lip or lower lip extending outwardly of the first edge guard; and
the second edge guard covers the second side edge, at least portions of the third side edge and the fourth side edge, and at least one of the upper edge and the lower edge with a respective upper lip or lower lip extending outwardly of the second edge guard.
